(19) United States
(12) Patent Application Publication
(10) Pub. No.: US 2009/0305731 A1
(43) Pub. Date: Dec. 10, 2009

(54) DYNAMIC URL SELF-FORMATION IN ACCORDANCE WITH COMBINING CALLER & RECEIVER'S INFORMATION

(76) Inventor: Yong Jin Kim, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/279,182

(22) PCT Filed: Aug. 1, 2006
(86) PCT No.: PCT/KR06/03018

§ 371 Date: Dec. 17, 2008

(30) Foreign Application Priority Data
Feb. 17, 2006 (KR) 10-2006-0015688
Mar. 27, 2006 (KR) 10-2006-0027600

(51) Int. Cl. H04W 4/12

(52) U.S. Cl. 455/466

(57) ABSTRACT

The present invention relates to data communication system and method enabling the utilization of contents by accessing the wireless Internet through self-formation of a dynamic URL by the caller's terminal application. When the caller attempts a voice call or a data call, the contents menu list registered by the receiver (or contents provider) and the caller/receiver information are transferred to the caller's terminal through a paging channel. Then, an application software stored in the caller's terminal processes the service option and displays the menu based on the menu list and caller/receiver information. Subsequently, in response to the caller's menu utilization request, a dynamic URL is formed from the combination of the identification number and contents type of the menu selected by the caller and the caller/receiver information.

### TECHNICAL FIELD

The present invention relates to data communication system and method enabling the utilization of contents by accessing the wireless Internet through self-formation of a dynamic URL by the caller's terminal application. When the caller attempts a voice call or a data call, the contents menu list registered by the receiver (or contents provider) and the caller/receiver information are transferred to the caller's terminal through a paging channel. Then, an application software stored in the caller's terminal processes the service option and displays the menu based on the menu list and caller/receiver information. Subsequently, in response to the caller's menu utilization request, a dynamic URL is formed from the combination of the identification number and contents type of the menu selected by the caller and the caller/receiver information.

### BACKGROUND ART

With the advancement of mobile communication services and Internet services, we can access and use the Internet wirelessly anytime and anywhere, using terminals. A wireless Internet user accesses the wireless Internet using a terminal by one of the following processes: accessing a contents portal site provided by a mobile service provider and using the registered contents; accessing the phone page of a contents provider using abbreviated number and particular key; and accessing the URL address containing message through the SMS message transferred from a contents provider. In all of these methods, the moment a user decides to use wireless Internet contents, a data channel is assigned for him/her for accessing the wireless Internet contents and thus a data communication fee will be charged. When a data channel is assigned and the user checks the wireless Internet contents, he/she has to pay for the data communication fee even if when he/she quits accessing the wireless Internet because he/she cannot find the contents he/she wants. This is a serious setback against the boost of data communication.

Further, in the afore-mentioned methods, a URL is mapped for each contents menu provided by the contents provider. When a user selects a particular menu, he/she can access the server of the contents provider and the corresponding contents page through the URL. The transfer of the URL along with the contents menu is the main cause of the increased wireless Internet contents volume, which increases data transfer time and, consequently, the user's data communication fee. To solve this problem, a method of reducing the data volume of URL using a self-defined abbreviated code has been proposed. But, the abbreviated code system is applied limitedly only during the access to the wireless Internet. Once accessing the wireless Internet, the URL is mapped for all the menus of the contents page.

### DISCLOSURE OF INVENTION

### Technical Problem

The present invention has been made to solve the afore-mentioned problems. In accordance with the present invention, when a caller attempts a voice call or a data call, the contents menu list registered by a receiver (or contents provider) and the caller/receiver information are transferred to the caller's terminal through a paging channel of a mobile switching network. Then, an application software stored in the caller's terminal processes the service option and displays the menu based on the menu list and caller/receiver information. Thus, the mobile service provider can save resources since a data channel needs not be continuously assigned to the caller while he/she is searching the menu. And, the calling user can search the initial menu provided by the contents provider without having to pay the data communication fee. Further, the present invention provides the calling user's convenience since the contents path depth can be reduced. Since a dynamic URL is self-formed by the application software in the caller's terminal from the combination of the caller/receiver information, there is no need to map a URL for each menu of the contents page, which reduces the display volume and, thus, data transfer time and fee. In addition, the receiving contents provider can provide caller-specific contents and ads to a particular caller. And, the calling user can utilize the tailor-made wireless Internet contents provided by the receiver more quickly and conveniently.

### Technical Solution

The present invention is characterized by a data communication system which enables access to the wireless Internet and utilization of contents when a caller attempts a voice call or a data call by transferring the contents menu list registered by the receiver (or contents provider) and the caller/receiver information to the caller's terminal through a paging channel, processing service option and displaying menu based on the menu list and the caller/receiver information using an application software stored in the caller's terminal and self-forming a dynamic URL from the combination of the identification number and contents type selected by the caller's menu utilization request and the caller/receiver information at the caller's terminal.

The present invention is also characterized by a data communication system comprising: a service registration processing means wherein, when a receiver (or contents provider) accesses a contents server, selects his/her initial contents menu and constructs and stores a menu list for a service registration, a service server linked with the server and connected to a mobile communication network stores the menu list; a data transfer means which, when a caller attempts a signal calling, determines if the caller and the receiver subscribe for the service and wherein, if the caller and the receiver subscribe for the service, the service server adds the information of the corresponding caller and receiver received through the mobile communication network to the contents menu list of the receiver and transfers it to the caller through a paging channel; a service processing means wherein, when the caller/receiver information and the contents menu list are transferred, an application software stored in the caller's terminal is executed automatically to perform a service option designated by the receiver and, of the basic menus stored in the application software, the menu corresponding to the menu identification number registered by the receiver is displayed on the caller's terminal; a wireless Internet accessing means wherein, when one of the menus displayed on the caller's terminal is selected to request for the corresponding contents page, the application software self-forms a dynamic URL from the combination of the identification number of the menu selected by the caller, the contents type and the caller/receiver information and a contents page accessing is performed thereby; and an idle screen control means which, when the contents menu list is transferred with a menu identification number of a particular ad, automatically accesses the ad page by combining the ad menu identification number and the caller/receiver information while the caller searches the menu on his/her terminal and displays the corresponding ad page on the caller's terminal while the requests for the transfer of contents and waits during the data transfer idle time.

The afore-described construction of the present invention is for the case when the caller attempts an access through a voice call. A contents server may replace the service server when the caller attempts an access through a data call.

The present invention is further characterized by a data communication system enabling the utilization of contents by accessing the wireless Internet through self-formation of a dynamic URL by the caller's terminal application. When the caller attempts a voice call or a data call, the contents menu list registered by the receiver (or contents provider) and the caller/receiver information are transferred to the caller's terminal through a paging channel. Then, an application software stored in the caller's terminal processes the service option and displays the menu based on the menu list and caller/receiver information. Subsequently, in response to the caller's menu utilization request, a dynamic URL is formed from the combination of the identification number and contents type of the menu selected by the caller and the caller/receiver information.

### ADVANTAGEOUS EFFECTS

The present invention provides data communication system and method enabling the utilization of contents by accessing the wireless Internet through self-formation of a dynamic URL by the caller's terminal application. When the caller attempts a voice call or a data call, the contents menu list registered by the receiver (or contents provider) and the caller/receiver information are transferred to the caller's terminal through a paging channel. Then, an application software stored in the caller's terminal processes the service option and displays the menu based on the menu list and caller/receiver information. Subsequently, in response to the caller's menu utilization request, a dynamic URL is formed from the combination of the identification number and contents type of the menu selected by the caller and the caller/receiver information. The caller can search the menu of the contents provided by the receiver without charge. If he/she determines to utilize the contents, he/she can access the wireless Internet and utilize the contents. The mobile service provider can save resources because a data channel needs not be continuously assigned to the caller during the search of the menu. Further, the present invention provides the calling user's convenience since the contents path depth can be reduced. Since a dynamic URL is self-formed by the application software in the caller's terminal from the combination of the caller/receiver information, there is no need to map a URL for each menu of the contents page, which reduces the display volume and, thus, data transfer time and fee. In addition, the receiving contents provider can provide caller-specific contents and ads to a particular caller. And, the calling user can utilize the tailor-made wireless Internet contents provided by the receiver more quickly and conveniently.

While the caller searches the contents menu, a particular information or ad registered by the contents provider is automatically displayed on the caller's terminal by an application software during each idle time. Thus, ads can be provided to the caller for several times with only one data communication fee charging. And, the efficiency of advertisement can be maximized since the ad can be provided to the selected targets only.

### BRIEF DESCRIPTION OF THE DRAWINGS

FIG. 1 illustrates an example of the connection of a mobile communication network, service server and contents server in accordance with the present invention.

FIG. 2 and FIG. 3 are service flowcharts illustrating the process by which a caller (100) utilizes service by attempting a voice call in accordance with the present invention.

FIG. 4 is a flowchart illustrating the process by which a caller (100) utilizes service by attempting a data call in accordance with the present invention.

FIG. 5 is a flowchart illustrating the process by which a dynamic URL is self-formed at the caller's terminal (100) based on the caller/receiver information and the menu list of the receiver in accordance with the present invention.

FIG. 6 illustrates the utilization of service in accordance with the present invention in view of functional process.

FIG. 7 illustrates the process by which an ad is selectively provided to the subscribing caller in accordance with the present invention.

FIG. 8 illustrates an example in which a caller (100) subscribes to and utilizes a service through a voice call, as illustrated in FIG. 2, FIG. 3, FIG. 5 and FIG. 7.

### MODE FOR THE INVENTION

Hereinafter, preferred embodiments of the present invention are described in further detail referring to the attached drawings.

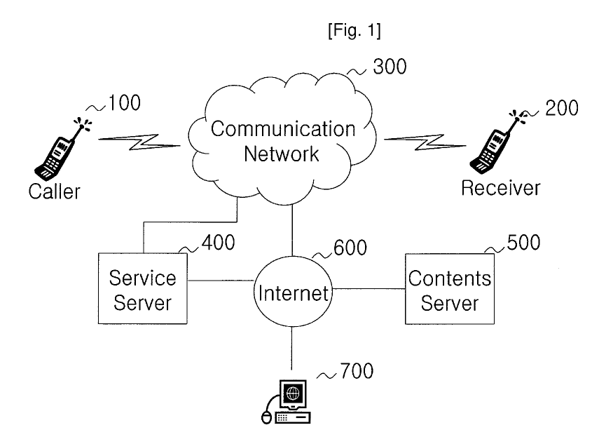

FIG. 1 illustrates an example of the connection of a mobile communication network, service server and contents server in accordance with the present invention.

A contents server (500) is connected to the caller's wireless terminal (100) through a mobile communication network (300) and the Internet (600) for the caller's service utilization, connected to the receiver's wireless terminal (200) through the mobile communication network (300) for the service registration of the receiving contents provider and the construction of the contents menu and connected to a PC (700) through the Internet (600). The receiver (200) can register self-created contents or the contents provided by the contents server (500) using the wireless terminal or PC and provide it to the caller (100).

A service server (400) is connected to the contents server (500) for the storing of the contents menu list of the receiver (200) registered in the contents server (500) through the Internet (600) and is connected to the caller's terminal (100) and the receiver's terminal (200) for providing the caller/receiver information to the caller (100) through the mobile communication network (300).

The mobile communication network (300) comprises a mobile switch, a home location register (HLR), a base station controller, a base station, a packet data serving node (PDSN), etc. For the purpose of simplification, it will be called the mobile communication network or mobile switch.

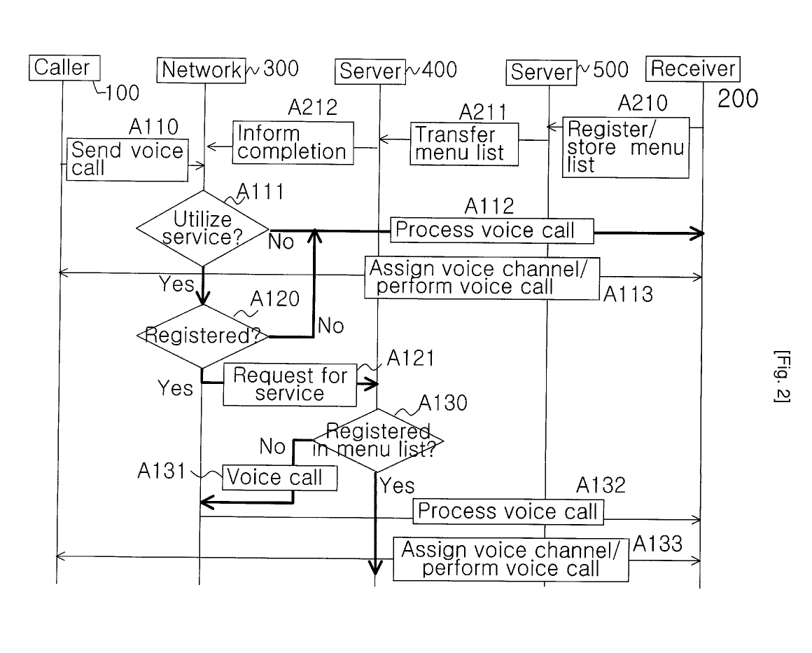

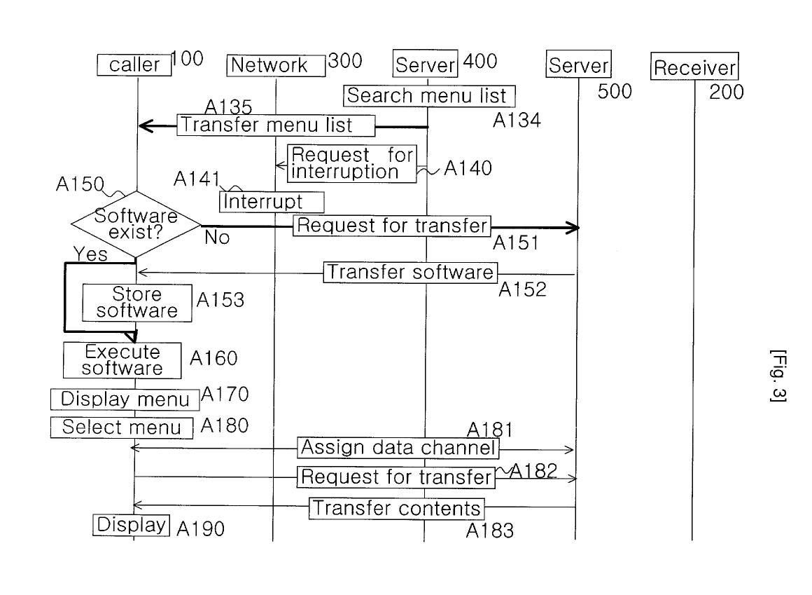

FIG. 2 and FIG. 3 are service flowcharts illustrating the process by which the caller (100) utilizes service by attempting a voice call in accordance with the present invention.

When the receiver (200) request for a service registration, the contents server (500) registers and stores the menu list including the identification number of the contents menu selected by the receiver (100), contents type and service option (A210). The contents server (500) transfers the stored menu list to the service server (400) (A211). The result is informed to the mobile switch (300) and the completion of the service registration and menu list storing is informed to the subscriber (A212).

When the caller (100) transmits a voice call signal (A110), the mobile switch (300) checks if the caller's terminal (100) can utilize the service (A111). Unless the service is available, voice call processing is carried out (A112). That is, a voice channel is assigned to provide a voice call between the caller and the receiver (A113).

If the caller's terminal (100) can utilize the service, it is determined if the service is registered by the receiver (200) (A 120). Unless the receiver (200) has registered the service, a voice call processing is carried out as above (A112). A voice channel is assigned to provide a voice call between the caller and the receiver (A113).

If the caller (100) can utilize the service and the receiver (200) has registered the service, the mobile switch (300) requests for the service to the service server (400) and, at the same time, transfers the mobile identification number (MIN) of the caller/receiver and other information (A121). The service server (400) checks if the caller's mobile identification number (MIN) is registered in the caller-specific menu list registered by the receiver (200) (A130). Unless it is registered, the service server (400) requests for a voice call processing to the mobile switch (300) (A131). Through voice call processing (A132), a voice channel is assigned and a voice call is carried out between the caller and the receiver (A133). If the caller's mobile identification number (MIN) is stored in the caller-specific menu list of the receiver (200), the corresponding caller's menu list is searched (A134) and, then, transferred to the caller (100) through the paging channel of the mobile communication network as combined with the caller/receiver information transferred from the mobile switch (300) (A135). The caller/receiver information may include the caller's location information provided by the home location register (HLR), the receiver's mobile identification number (MIN), reception status information, etc. If the data transfer through the paging channel is completed, a transfer completion message is transferred to the service server (400). Then, the service server (400) requests for the interruption of the voice call to the mobile switch (300) (A140). The mobile switch (300) interrupts the voice call attempted by the caller (100) (A141).

The caller's terminal (100) receives the caller/receiver information and menu list from the mobile switch (300) and checks if the terminal application software is stored in the terminal (A150). Unless the terminal application software is stored, it requests for the transfer of the terminal application software to the contents server (500) (A151). The contents server (500) receives the request for the transfer of the terminal application software from the caller (100) and transfers the terminal application software to the caller (100) (A152). The caller (100) stores the transferred terminal application software in the terminal (A153). If the application software is already stored in the caller's terminal (100) or if the storing is completed, the terminal application software is executed (A160).

The terminal application software is a software designed to be run on a terminal supporting a WIPI (wireless Internet platform for interoperability) platform. According to the program input, it can perform calculation while adjusting the basic key values of the terminal. In the present invention, the application software stores the registered basic menu and, upon request, displays the menu list for the receiver. It adjusts the program execution time based on the service option set by the receiver, automatically accesses a particular page and self-forms a dynamic URL through the combination of the caller/receiver information and the identification number and type of the menu selected by the caller.

The terminal application software processes service option and displays menus on the caller's terminal based on the menu list of the receiver transferred from the service server (400) and the caller/receiver information (A170). When the caller (100) selects one of the menus displayed on the terminal (A180), the terminal application software self-forms a dynamic URL from the combination of the identification number and type of the selected menu and the caller/receiver information (A190).

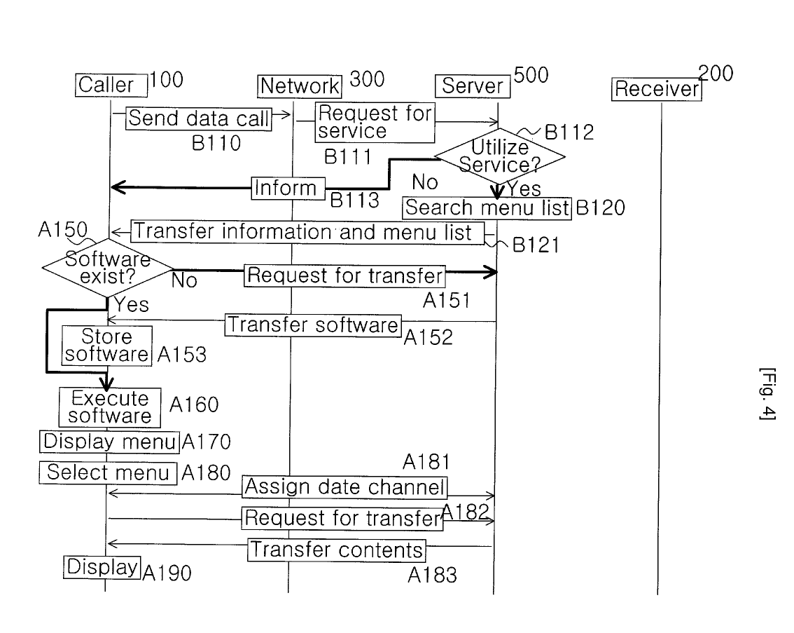

FIG. 4 is a flowchart illustrating the process by which a caller (100) utilizes service by attempting a data call in accordance with the present invention.

In the figure, the process by which the receiver (200) registers the service is the same as in FIG. 2. However, the role of the contents server (500) is extended. It replaces the service server (400) and performs part of the roles of the mobile switch (300).

The figure is based on the assumption that the receiver (200) has completed registration of the service.

When the caller (100) access the phone page of the contents provider using the abbreviated number and particular key of the contents provider or access the URL address included in the SMS message transmitted from the contents provider, the caller (100) sends a data call (B110) and the mobile communication network (300) links the data call to the packet network and request for the service to the contents server (500) in which the contents of the receiving contents provider (200) is stored (B111). The contents server (500) checks if the caller's terminal (100) can utilize the service (B112). If the service is unavailable, it informs the caller (100) that he/she cannot utilize the service (B113). If the service is available, the contents server (500) request for the search of the caller-specific menu list.

The menu list information registered by the receiver (200) for the caller (100) is searched (B120) and the menu list and the caller/receiver information is transmitted to the caller's terminal (100) through the paging channel as in FIG. 3. The following process is the same as in FIG. 3.

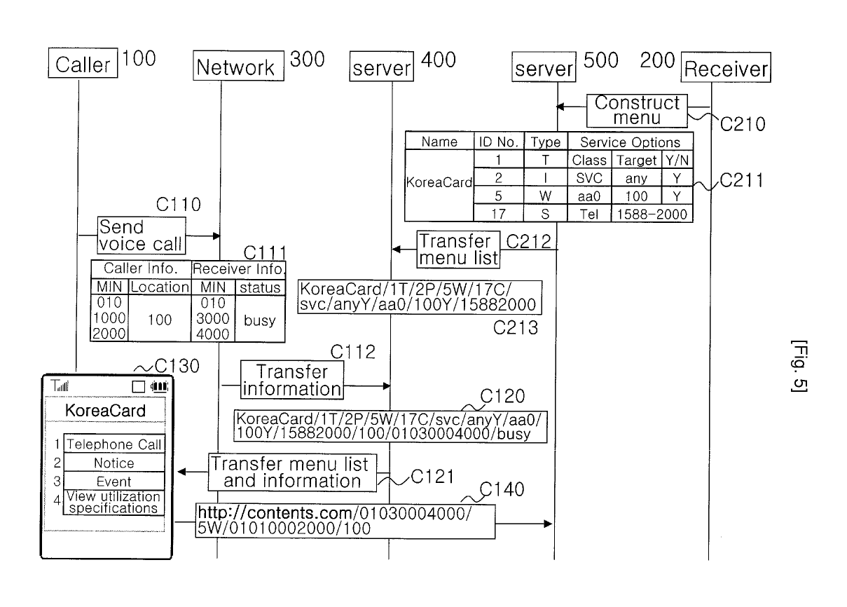

FIG. 5 is a flowchart illustrating the process by which a dynamic URL is self-formed at the caller's terminal (100) based on the caller/receiver information and the menu list of the receiver in accordance with the present invention.

The receiver (200) accesses the contents server (500) and selects the menu he/she wants from the basic contents menus provided by the server (C210). For each basic menu registered in the contents server (500) are mapped the identification number and contents type of the menu. If the receiver (200) selects a menu, the identification number and the contents type are stored along with the contents name and service option registered by the receiver (200) (C211) and transferred to the service server (400) (C212). The contents name may be a company name or service name designated by the receiver (200). And, the service option includes the time when the service is to be executed depending on the reception status, the identification number of the automatic access page depending on the caller's location information and whether the service will be executed or not.

The service server (400) receives the menu list from the contents server (500) and stores it (C213). When the caller (100) sends a voice call (C110), the mobile switch (300) checks the caller's mobile identification number (MIN) and other information including location and the receiver's mobile identification number (MIN) and other information including reception status (C111) and transfers the result to the service server (400) (C112). The service server (400) searches the menu list for the corresponding caller (100) from the caller-specifically registered menu lists, adds the caller/receiver information transferred from the mobile switch (300) to the menu list (C120) and transmit it to the caller's terminal (100) (C121).

The application software of the caller's terminal (100) checks the service option of the transmitted menu list. Based on the option, it determines the time when the service screen will be displayed (for example, when the receiver is calling, the power is off or without regard to the receiver's status), prepares for the screen display by accessing the corresponding page depending on whether automatic display screen (a screen displayed while the caller selects a menu and waits until the contents corresponding to the menu is displayed) is set and displays the menu according to the menu identification number of the receiver (200) transmitted from the service server (400) (C130).

When the caller (100) selects one of the menus displayed on his/her terminal, the application software forms a dynamic URL in order to access the page of the selected menu. The dynamic URL is formed from the combination of the caller's mobile identification number (MIN) preset in the application software, the domain of the contents (e.g., www.contents.com), the receiver's mobile identification number (MIN), the identification number and contents type of the menu selected by the caller (100), the caller's location information, etc. (C140). In the present invention, the service contents is primarily classified depending on the mobile identification number (MIN) of the contents provider and secondarily classified depending on the menu identification number. Accordingly, the page of the menu selected by the caller (100) can be accessed if the receiver's mobile identification number (MIN) and the identification number of the menu selected by the caller is known. Also, the characteristics of the contents can be predicted from the contents type. For example, “T” stands for telephone. If the “Telephone call” menu is selected from C130, the receiver may utilize a voice call with the telephone number registered in the service option. “I” stands for internal and represents the contents existing inside the contents server (500). “W” stands for Wap. When the caller selects a menu, the application software initiates a Wap browser and accesses the external domain registered in the contents server to utilize the wireless Internet. “S” stands for synchronization and represents the contents that link the contents server (500) with an external server. The dynamic URL formed from the combination includes the caller's mobile identification number (MIN) and location information, which are used to provide the contents designated by the receiver to a particular caller or a caller at a particular location.

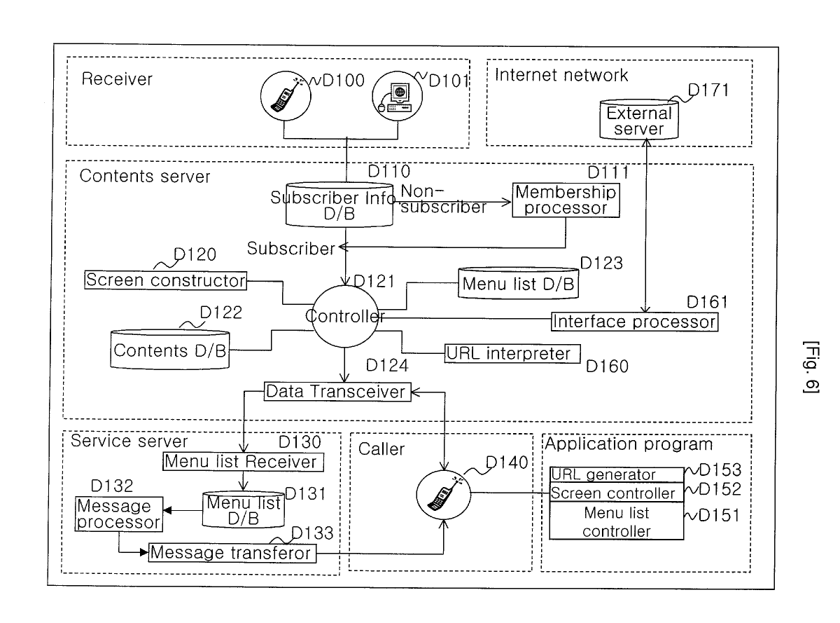

FIG. 6 illustrates the utilization of service in accordance with the present invention in view of functional process.

The contents server comprises a subscriber information D/B which, in response to the user's request, checks if the user is a subscriber of the service and proceeds a membership registration process unless the user is a subscriber and, a menu list D/B in which the identification number, contents type and service option of the menu selected by the subscriber is registered, a contents D/B in which the contents corresponding to the selected menu is registered and stored, a data transceiver which transmits the menu list set by the subscriber to the service server and transmits the contents of the contents D/B to the caller upon the caller's request, a URL interpreter which interprets the dynamic URL transferred from the caller through the data transceiver and an interface processor which enables access to the Internet contents by connecting to the Internet network and external server.

The service server receives the menu list of the receiver from the contents server and stores it in the menu list D/B. Then, upon the caller's request, the service server transfers the information extracted from the menu list D/B and the caller/receiver information provided from the mobile switch to the caller.

The application software stored in the caller's wireless terminal receives a message from the service server and displays the menu by decoding the message. Or, it forms a URL by receiving the menu from the caller to access the contents server. It also displays an automatic display screen, ad screen, event screen, etc. during the data transfer.

Hereunder is given a detailed description about the server and the application software.

The receiver (200) can apply for a service subscription or register and change the contents of his/her menu list using his/her own wireless terminal (D100) or PC (D101). When the receiver (200) accesses the subscriber information D/B of the contents server (500), the subscriber information D/B (D110) checks if the receiver (200) is a subscriber. Unless the receiver (200) is a subscriber of the service, a membership registration process is carried out by a membership processor (D111). Then, the receiver (200) information is stored in the subscriber information D/B (S110). If the receiver (200) is a subscriber of the service, the control is transferred to the controller (D121) of the contents server (500) and the receiver (200) may register or change the menu list.

The controller (D121) of the contents server (500) makes the screen constructor (D120) construct the menu selected by the receiving subscriber (200). Of the basic menus provided by the contents server (500) through the screen constructor (D120), the receiver (200) may select the menu and service option he/she wants to construct the initial menu screen, create the contents for the menu and registers it in the contents D/B or search for the contents D/B (D122). The receiver (200) may create and register caller-specific menu screens in the contents server (500). In this case, the specific menu screen may be provided for the corresponding caller. Subsequently, the controller (D121) stores the caller-specific menu list constructed by the receiver (200) in the menu list D/B (D123) and transfers it to the menu list receiver (D130) of the service server (400) through the data transceiver (D124).

The menu list receiver (D130) of the service server (400) receives the caller-specific menu list and transfers it to the menu list D/B (D131). When the caller (100) attempts a phone call to the receiver (200) using a wireless terminal (D140) to utilize the service in accordance with the present invention, the service server searches the menu list corresponding to the caller's and receiver's mobile identification numbers (MIN) in the menu list D/B and transfers the result to the message processor (D132). The processor combines the caller's and receiver's mobile identification numbers (MIN) and further information provided from the mobile switch (300) with the menu list and transfers the result to the wireless terminal (D140) of the caller (100) through the message transferor (D133).

When the wireless terminal (D140) of the caller receives the message, the application software in the terminal is executed. The menu list processor (D151) receives the menu identification number included in the message, maps it with the basic menu stored in the application software and transfers the menu details and service option to the screen controller (D152). The screen controller (D152) executes the service option provided from the menu list processor (D151) and displays the screen according to the menu details. When the caller (100) selects a menu, the application software transfers the corresponding key input to the URL generator (D153), which forms a URL from the combination of the identification number and contents type of the corresponding menu and the caller/receiver information for accessing the contents server.

The URL interpreter (D160) of the contents server interprets the URL, so that the contents in the contents D/B can be transferred to the caller or the caller can utilize various external contents by accessing through the interface processor (D161), as connected to the Internet network or external server (D171).

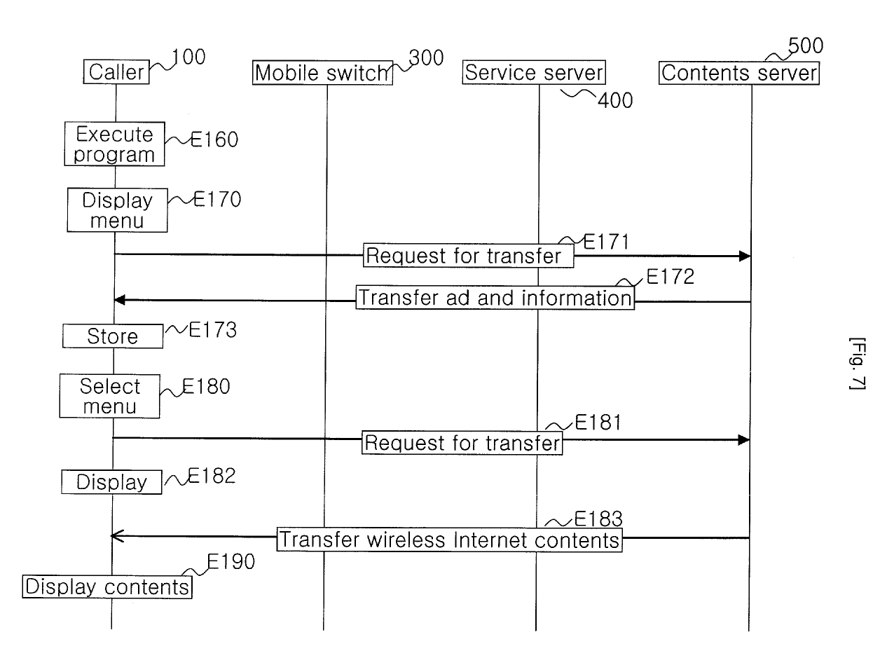

FIG. 7 illustrates the process by which an ad is selectively provided to the subscribing caller in accordance with the present invention.

The process of caller's or receiver's service registration, caller's calling and receiver's menu list reception is the same as in FIG. 2.

When the caller (100) receives the receiver's menu list, the caller's terminal application software is executed (E160) and the corresponding menu is displayed (E170). Subsequently, the terminal application software combines the caller's mobile identification number (MIN) and the identification number of the ad menu included in the service option to form a dynamic URL. An automatic accessing to the contents server (500) is carried out using the dynamic URL to request for the ad page (E171). Then, the contents server (500) transfers the corresponding contents to the caller (100) (E172). The caller (100) stores the contents transferred from the contents server (500) (E173). When the caller (100) selects a menu (E180) and request for the corresponding contents (E181), the stored ad page may be automatically displayed and provided to the caller (100) (E182). The ad screen disappears when the contents requested by the caller (100) is transferred and displayed (E183, E190). It may be displayed again when the caller (100) quits the utilization of the wireless Internet. Further, the caller's location information may be included in the URL of the ad page in order to provide a selective ad screen depending on the caller's location.

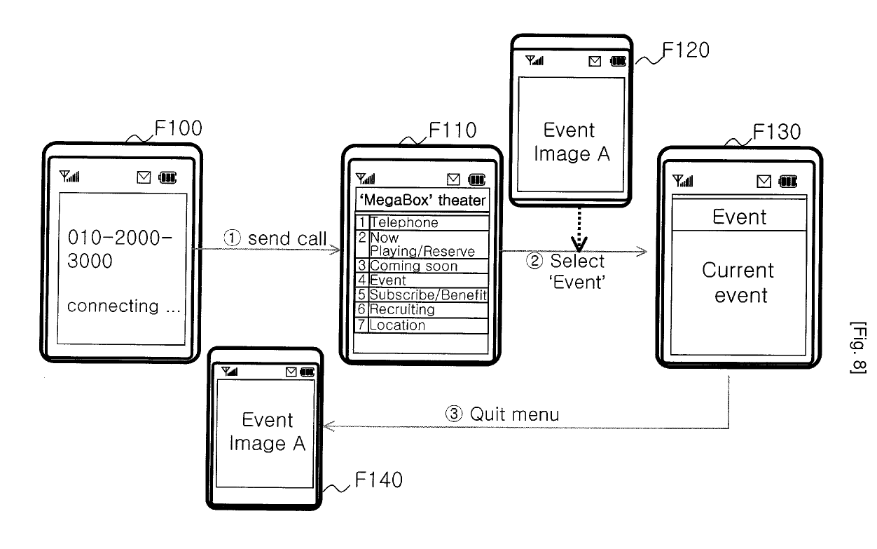

FIG. 8 illustrates an example in which a caller (100) subscribes to and utilizes a service through a voice call, as illustrated in FIG. 2, FIG. 3, FIG. 5 and FIG. 7.

When the caller (100) sends a voice call to a particular movie theater registered for service in Seoul (caller's location information code; 100) (E100), the initial menu screen registered by the movie theater is displayed (E110). When the caller (100) selects the “Event introduction” menu from the screen, the terminal application software automatically displays an ad screen (E120) based on the caller's location information code (100; Seoul). The ad screen (E120) disappears as soon as the caller (100) accesses the menu screen (E130) and may be displayed again when the data communication is stopped (E140). And, the “Event introduction” screen (E130) selected by the caller (100) is the one corresponding to the caller's location.

As described, it should be evident that the present invention can be implemented through a variety of configurations in the aforementioned technical field without affecting, influencing or changing the spirit and scope of the present invention. Therefore, it is to be understood that the examples and applications illustrated herein are intended to be in the nature of description rather than of limitation. Furthermore, the meaning, scope and higher conceptual understandings of the present invention as well as modifications and variations arise therefrom should be understood to be extensions of the present invention.

1. A data communication method for transferring contents to a caller in a mobile communication network connected to a contents server and a service server through the Internet, wherein
a receiver requests for a service and the receiver registers and stores the menu list for the contents to be provided to caller in the contents server;
when the caller sends a voice call to the receiver, a mobile switch in the mobile communication network determines if the caller's terminal can utilize the service and if the receiver has registered the service;
if the caller can utilize the service and the receiver has registered the service; the mobile switch transfers the caller/receiver information to the service server;
the service server transfers the menu list and the caller/receiver information to the caller;
after receiving the menu list and the caller/receiver information, an application software in the caller's terminal is executed to display menus for the caller and processes service options registered in the menu list;
the caller selects one of the displayed menus and requests the transfer of the selected one; and
the contents server transfers the contents of the requested menu to the caller.

2. A data communication method for transferring contents to a caller in a mobile communication network connected to a contents server and a service server through the Internet, wherein
a receiver requests for a service and the receiver registers and stores the menu list for the contents to be provided to caller in the contents server;
the caller sends a data call to the receiver to request for the utilization of the service to the contents server;
The contents server determines if the caller's terminal can utilize the service;
the contents server transfers the menu list and the caller/receiver information, which was registered in the contents server, to the caller;
after receiving the menu list and the caller/receiver information, an application software in the caller's terminal is executed to display menus for the caller and processes the service option registered in the menu list;
the caller selects one of the displayed menus and requests the transfer of the selected one; and the contents server transfers the contents of the requested menu to the caller.

3. The data communication method as set forth in claim 1, wherein the menu list includes an identification number and a contents type of the contents menu to be provided from the receiver to the caller, and service options.

4. The data communication method as set forth in claim 1 wherein the caller/receiver information includes the phone number and location of the caller and the phone number and receiving status of the receiver provided by the mobile communication network.

5. The data communication method as set forth in claim 2, wherein the caller/receiver information includes the caller's phone number registered in the contents server by the receiver.

6. The data communication method as set forth in claim 1, wherein
if the caller selects a menu from the menu list, a dynamic URL is formed in the caller's terminal from the combination of the identification number and contents type of the selected menu and the caller/receiver information; and
the resultant URL is transmitted to the contents server to request for the contents corresponding to the URL.

7. The data communication method as set forth in claim 6, wherein the dynamic URL includes the phone numbers and location information of the caller and the receiver.

8. The data communication method as set forth in claim 1, wherein, following the transfer of the menu list and the caller/receiver information to the caller;
a dynamic URL for a particular menu is automatically formed in the caller's terminal, based on the menu list and the caller/receiver information, and is transmitted to the contents server;
the contents corresponding to the URL is transferred from the contents server to the caller's terminal;
and the transferred contents is automatically displayed on the caller's terminal at a specific time.

9. A data communication system for transferring a contents to a caller in a mobile communication network connected to a contents server and a service server through the Internet,
wherein, the contents server comprises:
a subscriber information D/B which manages the receiver's service registration;
a menu list D/B which registers and stores the identification number, contents type and service option of the menu to be provided from the receiver to the caller;
a contents D/B which registers and stores the contents corresponding to the menu;
a data transceiver which transfers the contents stored in the contents D/B to the caller upon the caller's request;
a URL interpreter which interprets the dynamic URL transferred from the caller through the data transceiver; and
an interface processor for interfacing with the Internet; wherein, the service server comprises:
a menu list D/B which stores the menu list transferred from the contents server; and
a message transferor which transfers, to the caller's terminal, the menu list stored in the menu list D/B and the caller/receiver information provided from the mobile communication network; and
wherein, the caller's terminal comprises an application software which receives information from the service server, displays menus on the screen, forms a dynamic URL in response to the caller's menu input and transmits it to the contents server.
